(19) United States
(12) Patent Application Publication
(10) Pub. No.: US 2002/0107993 A1
(43) Pub. Date: Aug. 8, 2002

(54) Method and system of program management for using component model

(76) Inventors: Hiroyuki Wajima, Yokohama (JP); Nobuki Tsuchida, Yokohama (JP); Masao Sato, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/078,404

(22) Filed: Feb. 21, 2002

Related U.S. Application Data
(63) Continuation of application No. 09/884,067, filed on Jun. 20, 2001.

(30) Foreign Application Priority Data
Feb. 2, 2001 (JP) 2001-026250

(51) Int. Cl. G06F 9/46

(52) U.S. Cl. 709/312

(57) ABSTRACT

When acquiring component reference information from a home, a service utilization program delivers a component kind (for example, ordinary customer). The home holds one interface name, and manages a plurality of kinds of components satisfying the interface name. The home refers to a component reference information table, and sends back component reference information corresponding to the component kind delivered and to the interface name held. The service utilization program calls a component (for example, ordinary customer component) by utilizing the component reference information it acquires.

The present application is a continuation of application Ser. No. 09/884,067, filed Jun. 20, 2001 the contents of which are incorporated herein by reference.

### BACKGROUND OF THE INVENTION

This invention relates to a distributed object technology on the basis of a component model.

An information processing system constituted by utilizing the distributed object technology is called a “distributed object system”.

In this distributed object system, objects that are mounted in accordance with a predetermined rule for re-use are called “components”. Since the components are re-usable, they can be sold and purchased as commercial parts. A system that constitutes a system by re-use of the components is called a “component model”.

In the system based on the component model, a program offering a service activates the component, and a program utilizing a service calls the component. A desired processing is thus achieved. Here, the program providing the service is called a “service providing program” and the program utilizing the service, a “service utilization program”.

One of the problems in the system based on the component model is how the service utilization program acquires an identifier for calling an object or a component. Here, the identifier for calling the object or component is called “reference information”. The object that the service utilization program utilizes for acquiring the reference information of the component is called a “home”.

The first known example is described, for example, in “Enterprise JavaBeans Specification”, V1. 1 (1999) published by Sun Microsystems Inc., U.S.A. (“Enterprise JavaBeans” is the registered trademark of Sun Microsystems, Inc.). In this example, the component is called “Enterprise Bean” and the home, “EJBHome”.

The second known example is described, for example, in “CORBA Components” Vol. 1: Joint Revised Submission, (Aug. 2, 2000) published by Object Management Group, a standardization organization in U.S.A. Here, CORBA (Common Object Request Broker Architecture) represents a distributed object technology described in “The Common Object Request Broker: Architecture and Specification”, Revision 2.0 (1996) published by Object Management Group. (CORBA is the registered trademark of Object Management Group).

### SUMMARY OF THE INVENTION

In an embodiment obtained by the inventors, a procedure for calling the component by the service utilization program will be explained with reference to FIG. 2. A home 111 and a component 112 correspond to each other on the 1:1 basis. The home 111 holds component reference information 143 as reference information of the component 112. A naming service 120 is provided so as to manage the correspondence relation of an object name 1131 and reference information 132.

A service utilization program 100 first passes the object name 131 (ordinary customer, for example) of the home 111 (ordinary customer home, for example) corresponding to the component 112 (ordinary customer component, for example) that is to be called, to the naming service 120 and acquires reference information 132 of the home 111 (ordinary customer home, for example). Next, the service utilization program 100 calls the home 111 (ordinary customer home, for example) by utilizing the reference information 132 so acquired and acquires the component reference information 143. The service utilization program 100 then calls the component (ordinary customer component, for example) by utilizing the component reference information 143.

As described above, all of the component 112, the home 111 and the object name 11 31 registered to the naming service 120 correspond to one another on the 1:1 basis. In order to identify the kind of the component 112 to be called in the service utilization program 100, therefore, an operation manager of the system must manage the identifiability of the object names 1131 corresponding to all kinds of components 112 and must register them in advance to the naming service 120.

As the component model is expected to further spread widely, it can be easily anticipated that the distributed object system based on the component model becomes greater in scale and the service offered becomes further diversified. As internet services have been expanded and competition has become severer, frequency of the service change will become higher.

Now, let us consider the following problems.

In the component model, different kinds of components are provided in many cases in accordance with the service provided. When the service gets diversified, the number of object names registered to the naming service increases because the component and the object name registered to the naming service correspond to each other on the 1:1 basis. At this time, the operation manager of the system must manage the identifiability of the same number of object names at the number of kinds of services, that is, the number of kinds of components. Therefore, the management cost increases. When the frequency of the service change increases, the frequency of change and addition of the component increases, too. Further, the frequency of change and addition of the names registered to the naming service increases, and the cost of managing the registered names of the naming service by the operation manager increases.

It is therefore an object of the present invention to provide an appropriate program management method and system capable of executing name management of components.

In a system based on a component model, the present invention has its feature of providing a management area of the component reference information used to manage the correspondence of an interface name, a component kind for discriminating components satisfying the interface, and the component reference information.

Another feature of the present invention resides in that a component reference management part as a program for referring to a component reference information management area, inputting an interface name and a component kind and outputting corresponding component reference information is held.

Still another feature of the present invention resides in that a home is held whereby the home is a program for holding one interface name of a component, accepting as an input a component reference information request message holding a component kind as a parameter, acquiring the component kind from the component reference information request message, calling a component reference management part by using, as the input, this component kind and the interface name it holds, and outputting the component reference information.

According to the present invention, one home manages a plurality of kinds of components corresponding to one interface. Therefore, even when the number of kinds of components to be activated increases, the increase of the number of homes can be restricted. Since the home and the object name to be registered to the naming service correspond to each other on the 1:1 basis, the number of object names registered to the naming service can be decreased, too. Therefore, the operation manager can easily manage the identifiability of the object names used in the overall system, and the management cost can be reduced. Even when any change and addition of components occur, reference information can be acquired from the existing home when the component reference information management area is changed. Therefore, registration information of the naming service need not be managed, and the management cost of the naming service by the operation manager can be reduced.

### BRIEF DESCRIPTION OF THE DRAWINGS

FIG. 1 explains an operation principle of the present invention;

FIG. 2 explains an operation principle of an embodiment obtained by the inventors;

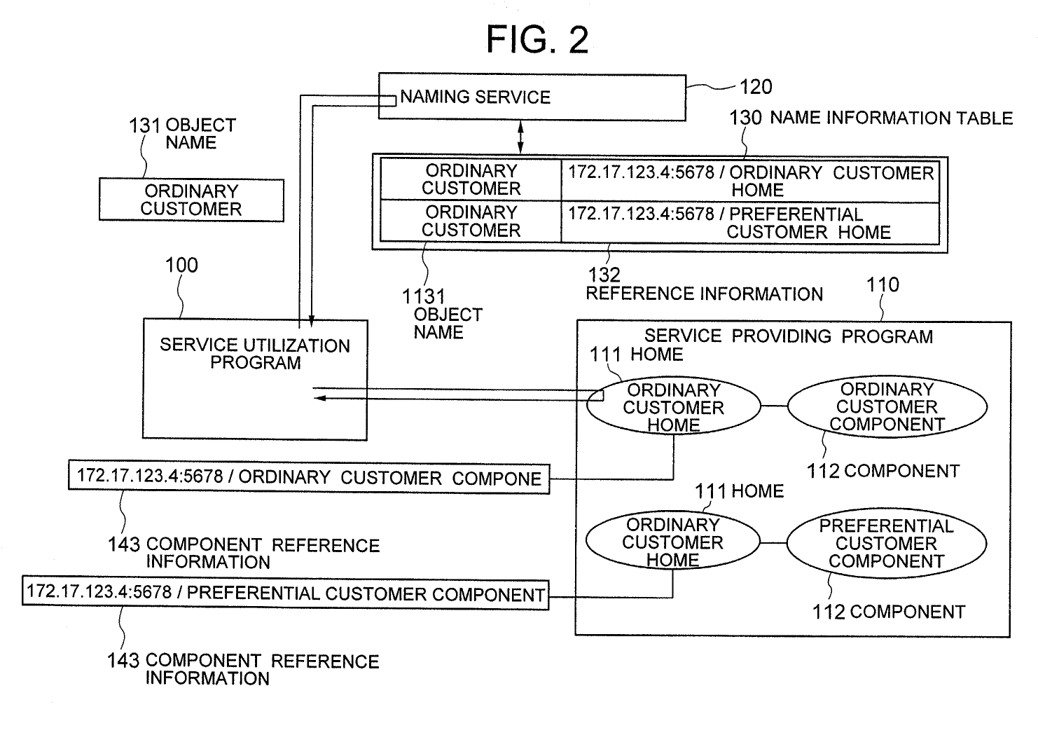

FIG. 3 explains a construction of a first embodiment and a flow of its processing;

FIG. 4 explains an operation principle of a second embodiment;

FIG. 5 explains a construction of the second embodiment and a flow of its processing; and

FIG. 6 explains an operation principle of a third embodiment.

### DESCRIPTION OF THE EMBODIMENTS

Preferred embodiments of the present invention will be explained hereinafter with reference to the accompanying drawings.

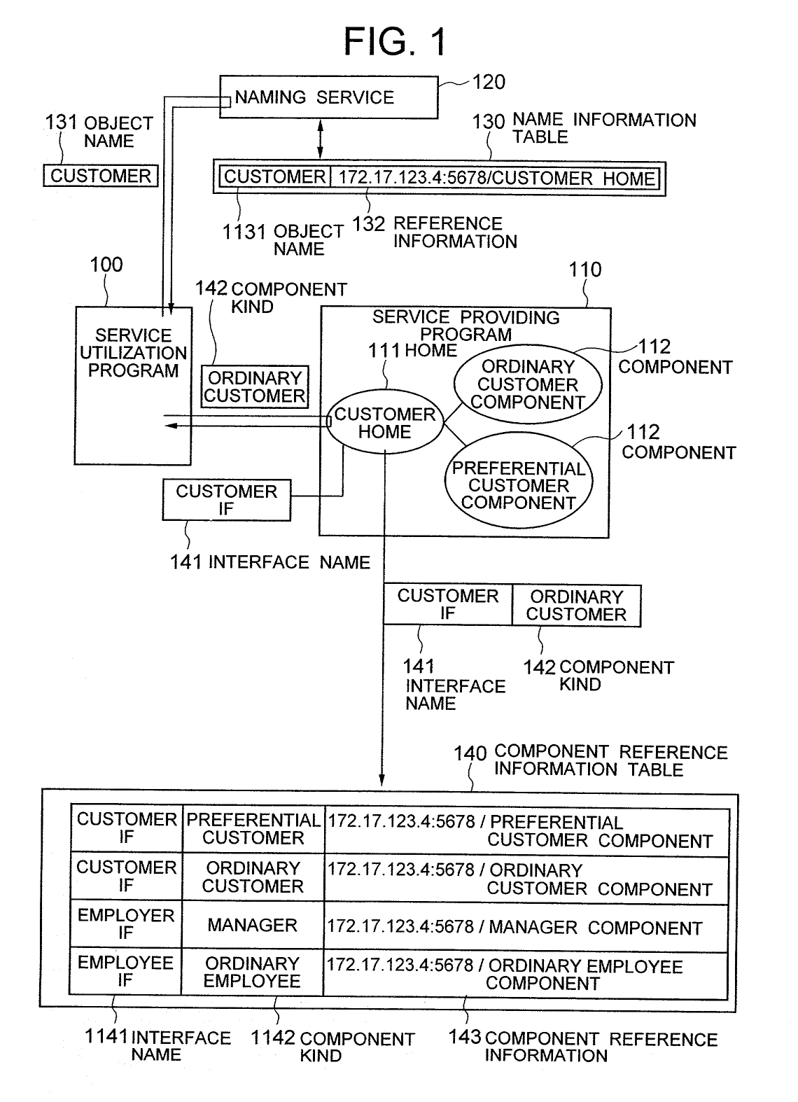

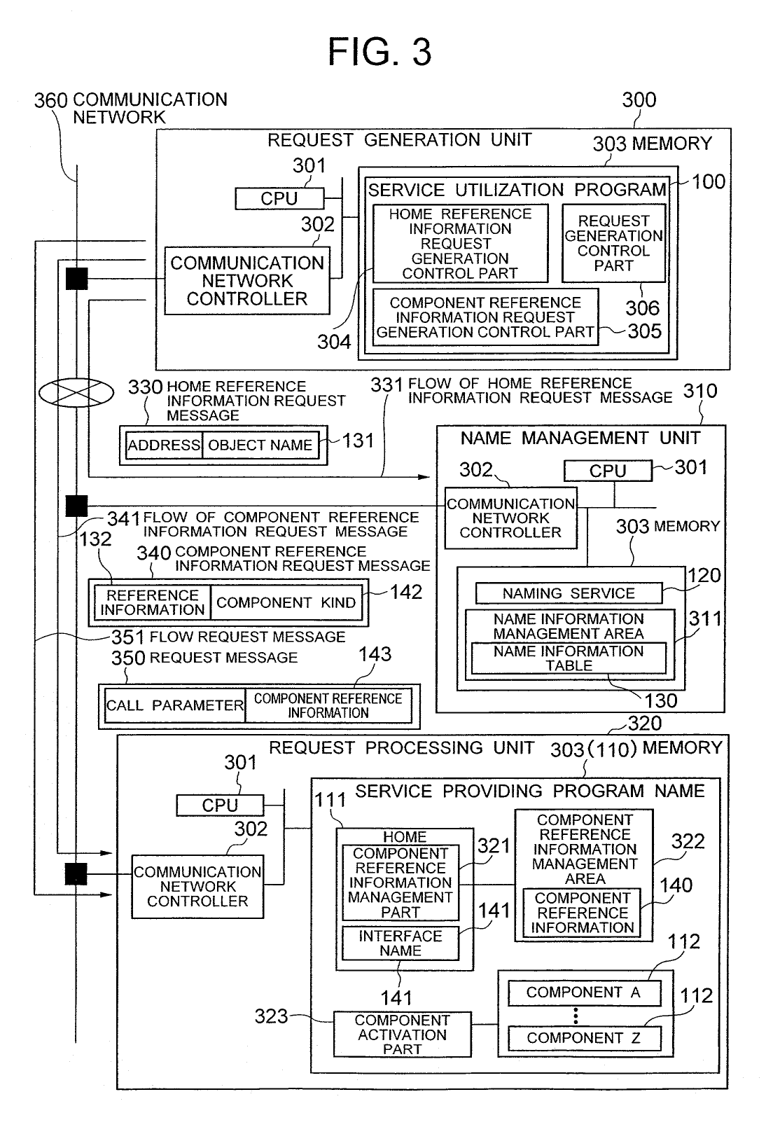

Initially, the first embodiment will be explained with reference to FIGS. 1 and 3.

This embodiment solves the problem that when a service is diversified, a management cost in a naming service increases. Further, this embodiment solves the problems that when the service is diversified, a memory consumption amount by a home increases, and because the number of object names registered to the naming service increases, the memory consumption amount in the naming service increases.

FIG. 1 shows an operation principle of this embodiment. First, a service utilization program 100 passes an object name 131 to a naming service 120 and acquires reference information 132 of a home 111. At this time, the naming service 120 refers to a name information table 130 representing the list of a correspondence relation between the object name 1131 and the reference information 132. Next, the service utilization program 100 calls the home 111 by utilizing the reference information 132 thus acquired, and acquires component reference information 143. The home 111 holds an interface name 141. The component reference information 143 is an identifier for calling a component 112. In this embodiment, it will be assumed that when the service utilization program 100 calls the home 111, a component kind 142 (ordinary customer, for example) is passed. At this time, the home 111 refers to a component reference information table 140 that manages the correspondence of the interface name 1141, the component kind 1142 and the component reference information 143, and sends back the component reference information 143 corresponding to the interface name 141 (customer IF, for example) that the home 111 holds and the component kind 142 that is passed. The service utilization program 100 calls the component 112 (ordinary customer component, for example) by using the component reference information 143 so acquired.

FIG. 3 shows the construction of this embodiment and the flow of its processing.

First, the construction of this embodiment will be explained.

A request generation unit 300 is the one that generates a home reference information request message 330, a component reference information request message 340 and a request message 350. The request generation unit 300 comprises a CPU 301, a communication network controller 302 and a memory 303. A service utilization program 100 exists on the memory 303. The service utilization program 100 comprises a home reference information request generation control part 304, a component reference information request generation control part 305 and a request generation control part 306. The request generation unit 300 is normally connected to a communication network 360 through a communication network controller 302.

A name management unit 310 is the one that manages a correspondence relation between the object name 1131 and the reference information 132, and comprises a CPU 301, a communication network controller 302 and a memory 303. The naming service 120 and a name information management area 311 are held on the memory 303. The name information management area 311 is the area that stores a name information table 130. The name management unit 310 is connected to a communication network 360 through a communication network controller 302.

A request processing unit 320 comprises a CPU 301, a communication network controller 302 and a memory 303. A service providing program 110 exists on the memory 303. The service providing program 110 comprises a home 111, a component 112, a component activation part 323 and a component reference information management area 322. The component reference information management area 322 stores a component reference information table 140. The request processing unit 320 is connected to a communication network 360 through a communication network controller 302.

Next, the flow of processing in this embodiment will be explained.

To acquire the reference information from the naming service 120, the service utilization program 100 generates the home reference information request message 330 by use of the home reference information request generation control part 304, and sends it to the name managing unit 310.

In the name managing unit 310, the naming service 120 receives the home reference information request message 330. Parameters constituting the home reference information request message 330 contains the object name 131. The naming service 120 refers to the name information management area 311, acquires the reference information 132 corresponding to the object name 131 contained in the request and returns the reference information 132 to the service utilization program 100.

Acquiring the reference information 132 from the naming service 120, the service utilization program 100 generates the component reference information request message 340 by use of the component reference information request generation control part 305 and sends it to the request processing unit 320.

In the request processing unit 320, the home 111 receives the component reference information request message 340. The home 111 holds the component reference information management part 321 and one interface name 141. The component reference information request message 340 comprises various parameters. In this embodiment, it is assumed that the component kind 142 is held as the parameter. The home 111 acquires first the component kind 142 from the component reference information request message 142 received. Next, the home 111 calls the component reference information management part 321 by use of the interface name 141 it holds and the component kind 142 acquired, as the input, and acquires the corresponding component reference information 143. At this time, the component reference information management part 321 refers to the component reference information management area 322 and outputs the component reference information 143 corresponding to the interface name 141 and the component kind 142 passed. Acquiring the component reference information 143, the home 111 returns it to the request generation unit 300.

The service utilization program 100 acquires the component reference information 143 from the home 111, generates the request message 350 by use of the request generation control part 306 to call the component 112 and sends it to the request processing unit 320.

In the request processing unit 320, the component activation part 323 receives the request message 350. The request message 350 comprises various parameters and holds the component reference information 143 as one of the parameters. The component activation part 323 acquires the component reference information 143 from the request message 350 and calls the corresponding component 112.

As described above, one home manages a plurality of kinds of components corresponding to one interface in this embodiment. Therefore, the increase of the number of homes can be restricted even when the number of kinds of components increases. Here, the home and the object name to be managed by the naming service correspond to each other on the 1:1 basis. In consequence, the number of object names to be managed by the naming service can be reduced. In other words, the operation manager can easily manage the identifiability of the object names used in the system as a whole and the management cost of the naming service can be reduced. Further, even when any change and addition of components occur, the component reference information can be acquired from the existing home by changing the component reference information table. Therefore, the name information table need not be changed, and the management cost of the naming service by the operation manager can be reduced.

Because the increase of the number of homes can be restricted, the use amount of the memory by the home in the request processing unit can be reduced. Though the same number of object names as the number of homes must be registered to the naming service, the number of object names registered to the naming service can be restricted when the number of homes is restricted. Consequently, the number of entries of the name information table can be restricted and the use amount of the memory in the name managing unit can be restricted.

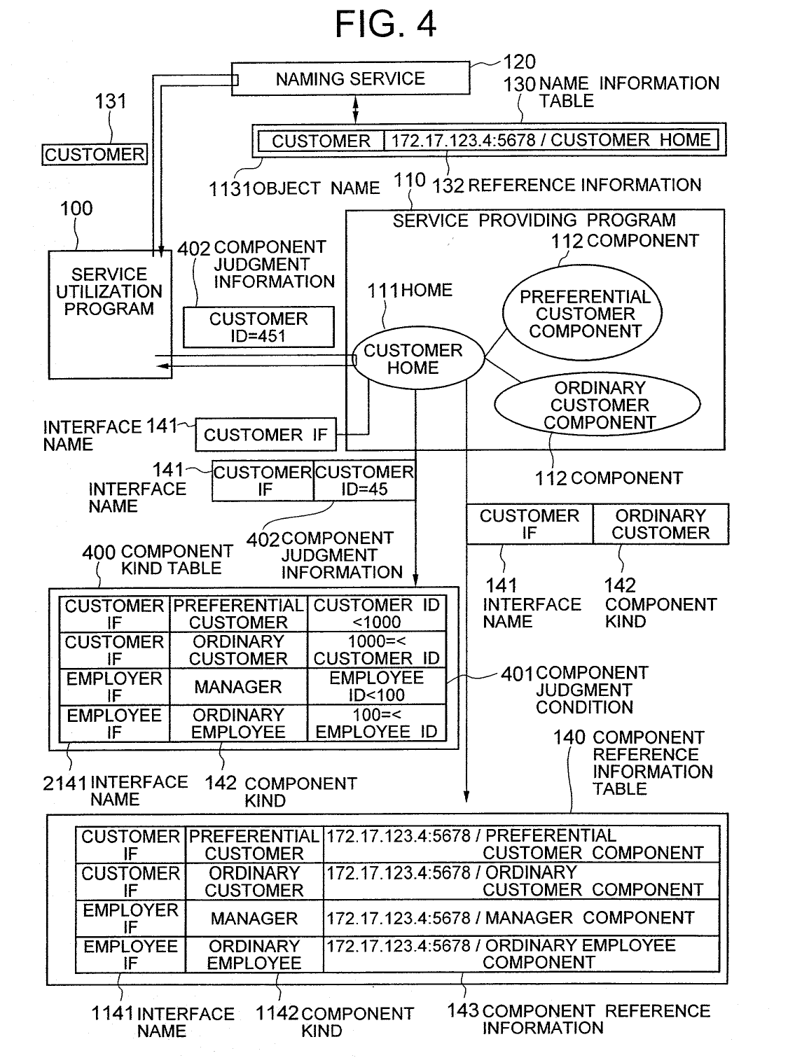

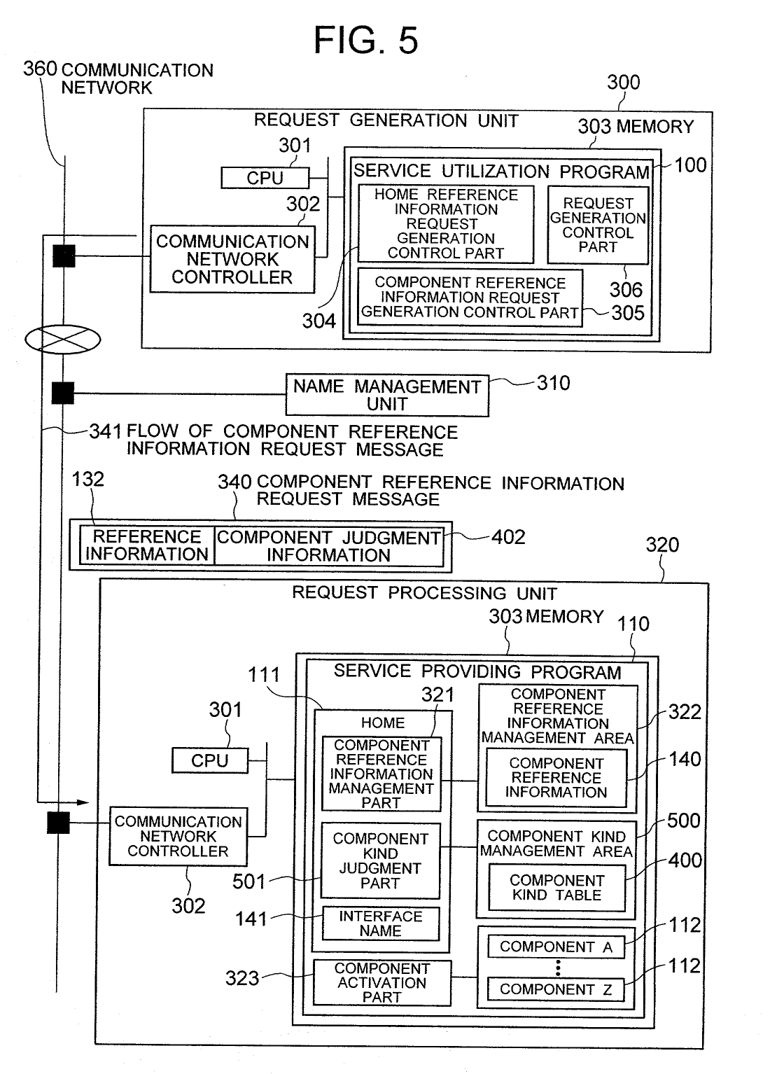

Next, the second embodiment of the present invention will be explained with reference to FIGS. 4 and 5.

To acquire the component reference information, the component kind is explicitly passed in the service utilization program in the first embodiment. In industrial information systems, however, the component kind may represent the service content. It is therefore preferred in some cases to avoid the exposure of the component kind to outside (service utilization program, for example) from the aspect of company strategy. When one home manages a plurality of kinds of components, this embodiment solves the problem that the component kind is exposed to the outside of the service offer program.

FIG. 4 shows an operation principle of this embodiment.

This embodiment manages the correspondence of an interface name 2141, a component kind 142 and a component judgment condition 401 as a component kind table 400. When the component reference information 142 is requested to the home 111, the component judgment information 402 as the information of the judgment material of the component kind 142 is passed. The component judgment information 402 is, for example, user information (user identifier, user roll, information representing authority, user location, information representing language used, kind of terminal used by user, etc). The home 111 first refers to the component kind table 400 on the basis of the component judgment information 402 it receives (such as customer ID=45) and the interface name 141 it holds (customer IF, for example), and acquires the component kind 142 (preferential customer, for example) corresponding to the component judgment condition 401 (customer ID<1000, for example). Next, the home 111 refers to the component reference information table 140 on the basis of the interface name 141 it holds (customer IF, for example) and the component kind 142 it acquires (preferential customer, for example), acquires the corresponding component reference information 143 (preferential customer component, for example) and returns it to the service utilization program 100.

FIG. 5 shows the construction of this embodiment and the processing procedure.

In this embodiment, a component kind management area 500 as an area for managing the component kind table 400 exists as one of the constituent elements of the service providing program 110. The home 111 as another constituent element of the service offer program comprises a component reference information management part 321 and a component kind judgment part 501, and holds one interface name 141 of the component.

When acquiring the component reference information 143 from the home 111, the service utilization program 100 generates the component reference information request message 340 by use of the component reference information request generation control part 305 and sends it to the request processing unit 320. The component reference information request message 340 comprises various parameters. This embodiment holds the component judgment information 402 as the parameter.

In the request processing unit 320, the home 111 receives the component reference information request message 340. The home 111 first acquires the component judgment information 402 from the component reference information request message 340 it receives. The home 111 then passes the interface name 141 it holds and the component judgment information 402 it acquires to the component kind judgment unit 501, and acquires the component kind 142. At this time, the component kind judgment part 501 refers to the component kind management area 500, acquires the corresponding component kind 142 on the basis of the interface name 141 and the component judgment information 402 passed, and outputs the component kind 142. Next, the home 111 passes the interface name 141 it holds and the component kind 142 it acquires to the component reference information management part 321, and acquires the component reference information 143. At this time, the component reference information management part 321 refers to the component reference management area 322, acquires the component reference information 143 corresponding to the interface name 141 and the component kind 142 passed, and outputs this component reference information 143. The home 111 returns the acquired component reference information 143 to the request generation unit 300.

As described above, according to this embodiment, the component kind need not be exposed to the outside of the service offer program.

Because the user information is utilized as the component judgment information, the home can select the component corresponding to the user, and can accomplish “customization” of the service.

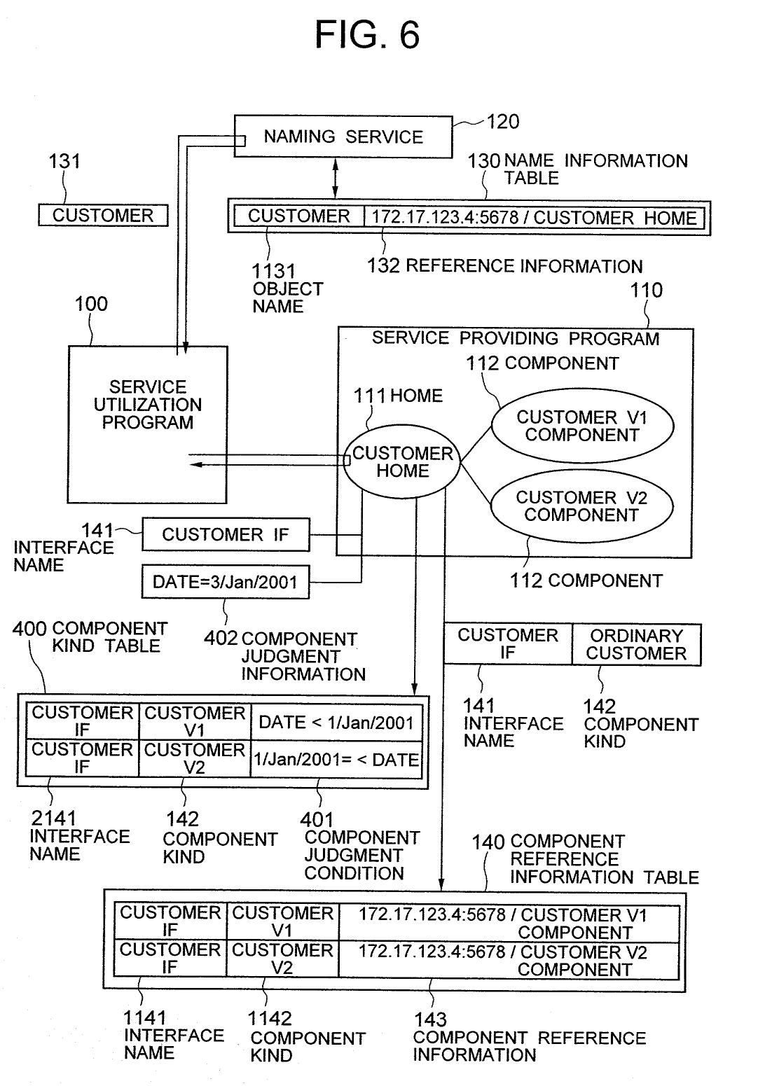

Next, the third embodiment of the present invention will be explained with reference to FIG. 6.

In the first and second embodiments, when the home judges the component corresponding to the received component reference information request message, it utilizes the information (component kind and component judgment information) passed from the service utilization program as the judgment material. Therefore, unless the information as the judgment material is contained in the component reference information request message, the home cannot judge the corresponding component from a plurality of kinds of components. This embodiment contemplates to solve the problem that one home can manage only one kind of component in the construction wherein the component reference information request message does not contain the information as the judgment material, hence the number of homes increases with the increase of the number of components and the memory consumption amount by the home increases.

FIG. 6 shows an operation principle of this embodiment.

In this embodiment, the home 111 manages the component judgment information 402. The component judgment information 402 is, for example, date and hour. When returning the component reference information 143 to the service utilization program 100, the home 111 refers to the component kind table 400 and acquires the component kind 142 (customer V2, for example) corresponding to the component judgment condition 401 (Jan. 1, 2000<=date) on the basis of the interface name 141 (customer IF, for example) it holds and the component judgment information 402 (date=Jan. 3, 2001, for example) it manages. The home 111 then refers to the component reference information table 140, acquires the component reference information 143 (customer V2 component, for example) corresponding to the interface name 141 (customer IF, for example) it holds and to the component kind 142 (customer V2, for example) it acquires, and returns the component reference information 143 to the service utilization program 100.

In this way, this embodiment manages a plurality of kinds of components by means of one home and can reduce the memory consumption amount by the home even in the construction in which the component reference information request message does not contain the component judgment information.

Because the date and the hour are utilized as the component judgment information, this embodiment can automatically exchange the components without the change of the service utilization program and without re-activation of the service offer program when version-up of the components is executed.

As described above, since one home manages a plurality of kinds of components corresponding to one interface, the increase of the number of homes can be restricted even when the number of kinds of components to be activated increases. Since the home and the object name to be registered to the naming service correspond to each other on the 1:1 basis, the number of object names registered to the naming service can be reduced, too. In consequence, the operation manager can easily manage the identifiability of the object names used in the overall system, and the management cost can be reduced. Further, even when any change and addition of the components occur, the reference information can be acquired from the existing home when the component reference information management area is changed. Therefore, the registration information of the naming service need not be managed and the management cost of the naming service by the operation manager can be reduced.

The present invention can thus accomplish appropriate component name management.

1. A method of controlling a program comprising:
a first step of referring to a component reference information management area storing interface names, component kinds and component reference information in association with one another, and outputting component reference information stored corresponding to an inputted interface name and an inputted component kind;
a second step of inputting a request requesting a component and holding a component kind as a parameter, acquiring said component kind from said request and outputting said component kind; and
a third step of holding said interface name, inputting said request requesting said component, outputting said request to said second step, inputting said component kind from said second step, outputting said component kind inputted and said interface name held to said first step, inputting said component reference information from said first step and outputting said component reference information inputted.

2. A method of controlling a program comprising:
a first step of referring to a component reference information management area storing interface names, component kinds and component reference information in association with one another, and outputting component reference information corresponding to an inputted interface name and an inputted component kind;
a second step of referring to a component kind management area storing interface names, component kinds and a component judgment condition in association with one another, and outputting said component kind stored and corresponding to said inputted interface name and said inputted component judgment information;
a third step of inputting a request requesting said component and holding said component judgment information as a parameter, acquiring said component judgment information from said request and outputting said component judgment information; and
a fourth step of holding an interface name, inputting said request requesting said component, outputting said request to said third step, inputting said component judgment information from said third step, outputting said component judgment information inputted and said interface name held to said second step, inputting said component kind from said second step, outputting said component kind inputted and said interface name held to said first step, inputting said component reference information from said first step and outputting said component reference information inputted.

3. A system for controlling a program comprising:
a first step of referring to a component reference information management area storing interface names, component kinds and component reference information in association with one another, and outputting component reference information corresponding to an inputted interface name and an inputted component kind;
a second step of referring to a component kind management area storing interface names, component kinds and a component judgment condition in association with one another, and outputting said component kind stored and corresponding to an inputted interface name and inputted component judgment information;
a third step of managing said component judgment information, inputting a request requesting said component, and outputting said component judgment information managed; and
a fourth step of holding said interface names, inputting said request requesting said component, outputting said request to said third step, inputting said component judgment information from said third step, outputting said component judgment information inputted and said interface name held to said second step, inputting said component kind from said second step, outputting said component kind inputted and said interface name held to said first step, inputting said component reference information from said first step and outputting said component reference information inputted.

4. A program control system comprising:
first means for referring to a component reference information management area storing interface names, component kinds and component reference information in association with one another, and outputting component reference information corresponding to an inputted interface name and an inputted component kind;
second means for inputting a request requesting said component and holding said component kind as a parameter, acquiring said component kind from said request and outputting said component kind; and
third means for holding said interface name, inputting said request requesting said component, outputting said request to said second means, inputting said component kind from said second means, outputting said component kind inputted and said interface name held to said first means, inputting said component reference information from said first means, and outputting said component reference information inputted.

5. A program control system comprising:
first means for referring to a component reference information management area storing interface names, component kinds and component reference information in association with one another, and outputting component reference information corresponding to an inputted interface name and an inputted component kind;
second means for referring to a component kind management area storing interface names, component kinds and a component judgment condition in association with one another, and outputting said component kind stored and corresponding to an inputted interface name and inputted component judgment information;
third means for inputting a request requesting said component and holding said component judgment information as a parameter, acquiring said component judgment information from said request and outputting said component judgment information; and
fourth means for holding said interface name, inputting said request requesting said component, outputting said request to said third means, inputting said component judgment information from said third means, outputting said component judgment information inputted and said interface name held to said second means, inputting said component kind from said second means outputting said component kind inputted and said interface name held to said first means, inputting said component reference information from said first means and outputting said component reference information inputted.

6. A program control system comprising:
first means for referring to a component reference information management area storing interface names, component kinds and component reference information in association with one another, and outputting component reference information corresponding to an inputted interface name and an inputted component kind;
second means for referring to a component kind management area storing interface names, component kinds and a component judgment condition in association with one another, and outputting said component kind stored and corresponding to an inputted interface name and inputted component judgment information;
third means for managing said component judgment information, inputting a request requesting said component and outputting said ‘component judgment information managed; and
fourth means for holding said interface name, inputting said request requesting said component, outputting said request to said third means, inputting said component judgment information from said third means, outputting said component judgment information inputted and said interface name held to said second means, inputting said component kind from said second means, outputting said component kind inputted and said interface name held to said first means, inputting said component reference information from said first means and outputting said component reference information inputted.

7. A program control program comprising the steps of:
a first step of referring to a component reference information management area storing interface names, component kinds and component reference information in association with one another, and outputting component reference information corresponding to an inputted interface name and an inputted component kind;
a second step of inputting a request requesting said component and holding said component kind as a parameter, acquiring said component kind from said request and outputting said component kind; and
a third step of holding said interface name, inputting said request requesting said component, outputting said request to said second step, inputting said component kind from said second step, outputting said component kind inputted and said interface name held to said first step, inputting said component reference information from said first step, and outputting said component reference information inputted.

8. A program control program comprising the steps of:
a first step of referring to a component reference information management area storing interface names, component kinds and component reference information in association with one another, and outputting component reference information corresponding to an inputted interface name and an inputted component kind;
a second step of referring to a component kind management area storing interface names, component kinds and a component judgment condition in association with one another, and outputting said component kind stored and corresponding to an inputted interface name and an inputted component judgment information;
a third step of inputting a request requesting said component and holding said component judgment information as a parameter, acquiring said component judgment information from said request and outputting said component judgment information; and
a fourth step of holding said interface name, inputting said request requesting said component, outputting said request to said third step, inputting said component judgment information from said third step, outputting said component judgment information inputted and said interface name held to said second step, inputting said component kind from said second step, outputting said component kind inputted and said information name held to said first step, inputting said component reference information from said first step, and outputting said component reference information inputted.

9. A program control program comprising the steps of:
a first step of referring to a component reference information management area storing interface names, component kinds and component reference information in association with one another, and outputting component reference information corresponding to an inputted interface name and an inputted component kind;
a second step of referring to a component kind management area storing interface names, component kinds and a component judgment condition in association with one another, and outputting said component kind stored and corresponding to an inputted interface name and an inputted component judgment information;
a third step of managing said component judgment information, inputting a request requesting said component and outputting said component judgment information managed; and
a fourth step of holding said interface name, inputting said request requesting said component, outputting said request to said third step, inputting said component judgment information from said third step, outputting said component judgment information inputted and said interface name held to said second step, inputting said component kind from said second step, outputting said component kind inputted and said interface name held to said first step, inputting said component reference information from said first step, and outputting said component reference information inputted.

10. A computer-readable recording medium storing a program control program, said program control program comprising the steps of:
a first step of referring to a component reference information management area storing interface names, component kinds and component reference information in association with one another, and outputting component reference information corresponding to an inputted interface name and an inputted component kind;
a second step of inputting a request requesting said component and holding said component kind as a parameter, acquiring said component kind from said request and outputting said component kind; and
a third step of holding said interface name, inputting said request requesting said component, outputting said request to said second step, inputting said component kind from said second step, outputting said component kind inputted and said interface name held to said first step, inputting said component reference information from said first step, and outputting said component reference information inputted.

11. A computer-readable recording medium storing a program control program, said program control program comprising the steps of:
a first step of referring to a component reference information management area storing interface names, component kinds and component reference information in association with one another, and outputting component reference information corresponding to an inputted interface name and an inputted component kind;
a second step of referring to a component kind management area storing interface names, component kinds and a component judgment condition in association with one another, and outputting said component kind stored and corresponding to an inputted interface name and inputted component judgment information;
a third step of inputting a request requesting said component and holding said component judgment information as a parameter, acquiring said component judgment information from said request and outputting said component judgment information; and
a fourth step of holding said interface name, inputting said request requesting said component, outputting said request to said third step, inputting said component judgment information from said third step, outputting said component judgment information inputted and said interface name held to said second step, inputting said component kind from said second step, outputting said component kind inputted and said interface name held to said first step, inputting said component reference information from said first step, and outputting said component reference information inputted.

12. A computer-readable recording medium storing a program control program, said comprising the steps of:
a first step of referring to a component reference information management area storing interface names, component kinds and component reference information in association with one another, and outputting component reference information corresponding to an inputted interface name and an inputted component kind;
a second step of referring to a component kind management area storing interface names, component kinds and a component judgment condition in association with one another, and outputting said component kind stored and corresponding to an inputted interface name and component judgment information;
a third step of inputting a request managing said component judgment information and requesting said component and outputting said component judgment information managed; and
a fourth step of holding said interface name, inputting said request requesting said component, outputting said request to said third step, inputting said component judgment information from said third step, outputting said component judgment information inputted and said interface name held to said second step, inputting said component kind from said second step:
outputting said component kind inputted and said interface name held to said first step, inputting said component reference information from said first step, and outputting said component reference information inputted.
